(19) United States
(12) Patent Application Publication
(10) Pub. No.: US 2021/0048138 A1
(43) Pub. Date: Feb. 18, 2021

(54) SUPPORTING STAND

(71) Applicant: SYNCMOLD ENTERPRISE CORP., New Taipei City (TW)

(72) Inventors: Yuan-Chi LEE, New Taipei City (TW); Chih-Hsin CHOU, New Taipei City (TW); Tung-Chiung CHEN, New Taipei City (TW); Ching-Hui YEN, New Taipei City (TW)

(21) Appl. No.: 16/913,601

(22) Filed: Jun. 26, 2020

Related U.S. Application Data
(60) Provisional application No. 62/887,326, filed on Aug. 15, 2019.

(30) Foreign Application Priority Data
Mar. 16, 2020 (TW) 109108609
Mar. 16, 2020 (TW) 109202964

(51) Int. Cl. F16M 11/04

(52) U.S. Cl. CPC F16M 11/046

(57) ABSTRACT

A supporting stand is disclosed, wherein the supporting stand is utilized for supporting a display on a working surface. The supporting stand comprises a base, a frame, and a bearing module, wherein the frame includes two side plates, a top plate, at least one supporting plate, and an accommodating space surrounded and defined by the side plates, the top plate, and the at least one supporting plate. The side plates and the at least one supporting plate is an integrally formed one-piece metal extrusion.

### CROSS REFERENCE TO RELATED APPLICATION

This application claims the benefit of U.S. Provisional Application Ser. No. 62/887,326 filed on Aug. 15, 2019 and the benefit of Taiwan Patent Application Serial No. 109108609 filed on Mar. 16, 2020, and No. 109202964 filed on Mar. 16, 2020. The entirety of each application is incorporated herein by reference.

### BACKGROUND OF THE INVENTION

### 1. Field of the Invention

The present invention relates to a supporting stand and a method of manufacturing a frame of the supporting stand. More particularly, the present invention relates to a supporting stand for supporting a display and a method of manufacturing a frame of the supporting stand for supporting a display.

### 2. Description of Related Art

Demands for a frame of a supporting stand for a display that has a thin and light appearance with asymmetrical shapes are continuously growing. In a case, if the die-casting method is used to manufacture a frame of which a top plate is inclined at an angle of 45° with a bottom plate, the de-molding convenience should be considered, and a draft angle will be necessary and be designed in advance. However, the design for the draft angle will increase the thickness of the frame. Thus, after de-molding, an extra cutting process is needed to cut off the thickened part of the frame. Also, if multiple plates such as mainboards, side plates, top plates, and bottom plates are manufactured by methods as stamping or the like, forming locking holes on each of the plates is necessary and these locking holes are formed correspondingly to their counterparts. These said plates are then assembled one by one by fasteners.

The present invention provides a method for manufacturing a frame of a supporting stand, which includes a first step of forming a metal extrusion by a metal extrusion process, then cutting, post-processing, and assembling a top plate are performed, and followed by puttying and spray-painting respectively to obtain the frame of the supporting stand.

### SUMMARY OF THE INVENTION

The main object of the present invention is to provide a supporting stand for supporting a display on a working surface. The supporting stand comprises a base being placed on the working surface; a frame being disposed on the base and including two side plates, a top plate, at least one supporting plate, a first putty layer, and an accommodating space surrounded and defined by the side plates, the top plate, and the at least one supporting plate, wherein the top plate is disposed between the side plates and the first putty layer is filled in the gaps between the top plate and the side plates; and a bearing module being disposed in the accommodating space and bearing the display. The side plates and the at least one supporting plate is an integrally formed one-piece metal extrusion. Each of the side plates includes a first edge, a second edge corresponding to the first edge, a top edge, and a bottom edge, wherein the first edges and the second edges extend along a first direction and the top edge extends along a second direction and connects with the top plate. The at least one supporting plate is adjacent to the first edge and the frame is connected to the base through the bottom edges of the side plates, wherein a length of the first edges and a length of the second edges are different.

In one embodiment, the first direction and the second direction are non-parallel to each other and include an angle smaller than 90°.

In one embodiment, the frame further includes a paint layer covering the exposed side plates, the top plate, and the first putty layer.

In one embodiment, the paint layer is formed as a continuous and smooth surface for making the frame an integrally formed outer appearance.

In one embodiment, each of the side plates further includes at least one first joint and the top plate includes at least one second joint corresponding to and being engaged to the at least one first joint.

In one embodiment, the at least one first joint has a through-hole and a screw, the at least one second joint has a blind hole, wherein the screw passes through the through-hole and is screwed to the blind hole.

In one embodiment, the framed further includes a second putty layer, the second putty layer is filled in the at least one through-hole and covers the screw.

In one embodiment, the paint layer further covers the exposed second putty layer.

In one embodiment, the first putty layer and the second putty layer include a stone powder, synthetic resin, and hardener, wherein the stone powder is calcium silicate, calcium carbonate, or mixture thereof.

In one embodiment, the paint layer includes a primer, a hardener, and a diluent, wherein the primer includes a rosin, a synthetic resin, an organic solvent, and a colorant.

In one embodiment, the at least one supporting plate has at least one locking hole, the bearing module is locked to the at least one supporting plate through a plurality of locking screws.

In one embodiment, each of the side plates includes at least one second engaging structure, the base includes at least one first engaging structure corresponding to the at least one second engaging structure, wherein the at least one first engaging structure and the at least one second engaging structure are engaged to each other.

In one embodiment, the side plates and the at least one supporting plate are made of aluminum or aluminum alloy.

In one embodiment, the bearing module includes at least one slide rail and a slider, the at least one slide rail is fixed to the frame, and the slider is slidably disposed on the slide rail and slides with respect to the frame.

In one embodiment, the supporting stand further comprises a backboard covering the at least one supporting plate from a side adjacent to the first edges of the side plates.

The present invention provides a method of manufacturing a frame of a supporting stand which comprises the steps of: an extrusion step: providing a mold with an opening, forming an extrusion block along a first direction by metal extrusion using the mode; a processing step: processing the extrusion block for forming an elongated body, wherein the elongated body includes two side plates and a supporting plate, wherein each of the side plates has a first edge, a second edge corresponding to the first edge, and a top edge connected to the first edge and the second edge, the supporting plate is formed between the side plates and is adjacent to the first edges; an assembling step: assembling a top plate between the side plates, the top plate is adjacent to the top edges of the side plates; and a puttying step: forming a first putty layer by filling a putty into a gap between the side plates and the top plate.

In one embodiment, the method of manufacturing a frame of a supporting stand further comprises a painting step: forming a paint layer covering the exposed side plates, the top plate, the supporting plate, and the first putty layer after the puttying step.

In one embodiment, the extrusion step, the side plates are vertical to the supporting plate.

In one embodiment, the processing step further includes removing a portion of the extrusion block so that the elongated body is formed with a length of the first edge smaller than a length of the second edge, and in each of the side plates, the top edge is angularly connected to the first edge and the second edge and extends in a second direction, wherein the first direction and the second direction are non-parallel.

In one embodiment, the method of manufacturing a frame of a supporting stand further comprises a post-processing step after the processing step and before the assembling step: forming at least one first joint on each of the side plates and forming at least one second joint corresponding to the at least one first joint on the top plate, wherein the at least one first joint is combined to the at least one second joint.

In one embodiment, in the post-processing step, the at least one first joint includes a through-hole and a screw, the at least one second joint is a blind hole, the screw passes through the through-hole and is screwed to the blind hole.

In one embodiment, the post-processing step further includes forming at least one locking hole of the supporting plate.

In one embodiment, the puttying step further includes forming a second putty layer by filling the putty into the through-hole and covering the screw.

In one embodiment, the painting layer in the painting step further covers the second putty layer.

In one embodiment, the method of manufacturing a frame of a supporting stand further comprises a grinding step after the puttying step and before the painting step: grinding the surfaces of the side plates, the top plate, the first putty layer, and the second putty layer.

In one embodiment, the extrusion step is performed by aluminum extrusion.

### BRIEF DESCRIPTION OF THE DRAWINGS

FIG. 1 is a front view showing an embodiment of a supporting stand of the present invention;

FIG. 2 is a back view showing an embodiment of a supporting stand of the present invention;

FIG. 3 is an exploded perspective view showing an embodiment of a supporting stand of the present invention;

FIG. 4 is a schematic perspective view showing an embodiment of an extrusion block of the present invention;

FIG. 5 is a schematic top view showing an embodiment of an extrusion block of the present invention;

FIG. 6 is a schematic perspective view showing an embodiment of an elongated body of the present invention;

FIG. 7 is a schematic diagram showing an embodiment of a frame of the present invention;

FIG. 8 is a rear view showing an embodiment of a frame of the present invention; and

FIG. 9 is a preparation flowchart of an embodiment of a frame of the present invention.

### DETAILED DESCRIPTION OF THE PREFERRED EMBODIMENT

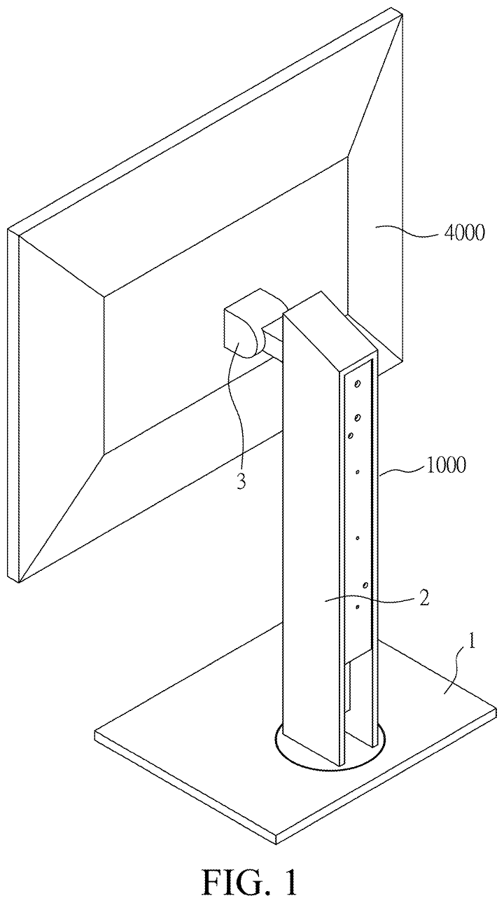

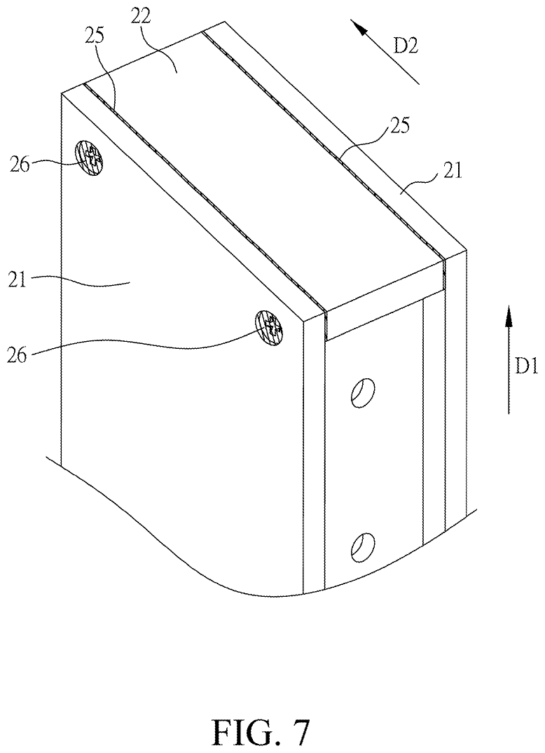

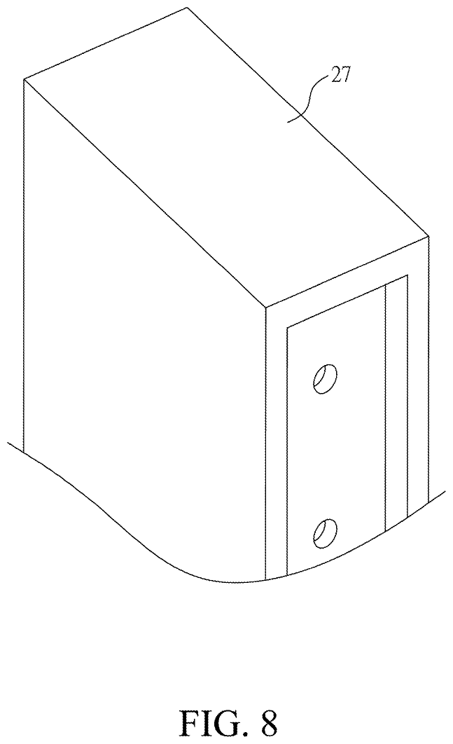

Please refer to FIG. 1 to FIG. 3 illustrating a schematic perspective view and an explosive perspective view of the supporting stand 1000 of one embodiment of the present invention. The supporting stand 1000 is used for supporting a display 4000 on a working surface, and comprises a base 1, a frame 2, and a bearing module 3. The base 1, allowing the frame 2 to be disposed thereon, is placed on the working surface and includes six first engaging structures 11. The frame 2 includes two side plates 21, a top plate 22, a supporting plate 23, an accommodating space 24, a first putty layer 25, a second putty layer 26, and a paint layer 27 (refer to FIG. 7 and FIG. 8), wherein the side plates 21 and the supporting plate 23 is an integrally formed one-piece metal extrusion manufactured by metal extrusion.

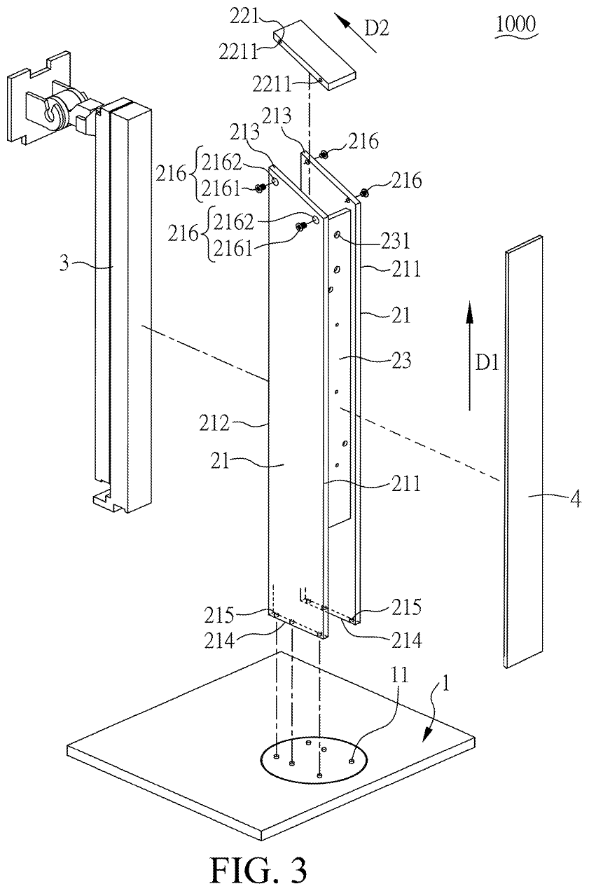

Please refer to FIG. 3, each of the side plates 21 includes a first edge 211, a second edge 212 corresponding to the first edge 211, a top edge 23, a bottom edge 214, three second engaging structures 215, and two first joints 216. In each of the side plates 21, the first edge 211 and the second edge 212 extend along a first direction D1. The top edge 213, which is connected to the first edge 211 and the second edge 212 by two ends, extends along a second direction D2 and is adjacent to the top plate 22. The bottom edge 214, which is also connected to the first edge 211 and the second edge 212 by two ends, is disposed corresponding to the top edge 213 and connected to the base 1. The second engaging structures 215 are formed on the bottom edge 214 and the first joints 216 are formed close to the top edge 213 and are respectively adjacent to the first edge 211 and the second edge 212. In the present embodiment, a length of the first edge 211 is smaller than a length of the second edge 212; moreover, the first direction D1 and the second direction D2 are non-parallel and include an angle smaller than 90°. In the embodiment, the first engaging structures 11 of the base 1 are formed as six protrusions arranged in two groups side-by-side, the second engaging structures 215 of the frame 2 are formed as six blind holes arranged in two groups side-by-side. The first engaging structures 11 and the second engaging structures 215 are correspondingly engaged to each other. Through the engagement, the frame 2 can be stably disposed on the base 1. In other embodiments, the first engaging structure 11 and the second engaging structure 215 are not limited thereto and can be other engaging structures that known in the art as long as the frame 2 can be stably disposed on the base 1. Also, in other embodiments, the length of the first edge 211 can be larger than the length of the second edge 212 according to the outer appearance design as long as the length of the first edge 211 and the length of the second edge 212 are different, that is, as long as the first direction D1 is not vertical to the second direction D2.

The top plate 22 is disposed between the side plates 21 and is adjacent to the top edge 213. The top plate 22 has four second joints 221 corresponding to the side plates 21 respectively and combined to the first joints 216, hence, the top plate 22 is fixedly disposed between the side plates 21. In the present embodiment, each of the first joints 216 has a screw 2161 and a through-hole 2162, each of the second joints 221 has a blind hole 2211, wherein the screws 2161 penetrate into the through-holes 2162 and are fixed to the blind holes 2211. The top plate 22 is inclined to the working surface because the top edges 213 of the side plates 21 extend along the second direction D2. In other embodiments, the combination of the top plate 22 and the side plates 21 is not particularly limited. That is, the structures of the first joints 216 and the second joints 221 can be any kind of combined structure in the art as long as the side plates 21 and the top plate 22 are fixedly connected. For example, in another embodiment, the top plate 22 covers the top edges 213 of the side plates 21 from above and is fixed to the side plates 21, the first joints 216 are blind holes formed on the top edges 213, and each of the second joints 221 has a screw and a through-hole, wherein the screws penetrate into the through-holes and are fixed to the blind holes of the side plates 21.

The supporting plate 23 is connected between the side plates 21 and adjacent to the first edges 211. The supporting plate 23 includes a plurality of locking holes 231 allowing the bearing module 3 to be fastened thereon. The number and the position of the locking holes 231 are not particularly limited and can be determined as needed.

The accommodating space 24 accommodating the bearing module 3 is surrounded and defined by the side plates 21, the top plate 22, and the supporting plate 23.

Please refer to FIG. 7, the first putty layer 25 is filled in the gaps between the top plate 22 and the side plates 21, the second putty layer 26 is filled in the through-holes 2162 and covers the screws 2161. In other embodiments, the filling of the first putty layer 25 and the second putty layer 26 is determined by the combination structure between the top plate 22 and the side plates 21 and is not particularly limited, as long as the first putty layer 25 and the second putty layer 26 are able to be filled into the gaps between the top plate 22 and the side plates 21 and the gaps or holes formed after combining the first joints 216 and the second joints 221 for making a smooth outer appearance. The first putty layer 25 and the second putty layer 26 include stone powder, synthetic resin, and hardener, wherein the stone powder is calcium silicate, calcium carbonate, or mixture thereof. However, in other embodiments, the first putty layer 25 and the second putty layer 26 may include other putty materials known in the art and are not particularly limited.

Refer to FIG. 8, the paint layer 27 covers the exposed parts of the side plates 21, the top plate 22, the first putty layer 25, and the second putty layer 26. Accordingly, the outer appearance of the frame 2 is continuous, smooth, and is visually integrally-formed. The paint layer 27 includes primer, hardener, and diluent, wherein the primer includes rosin, synthetic resin, organic solvent, and colorant. In other embodiments, the paint layer 27 may be other paint materials known in the art without particular limitation.

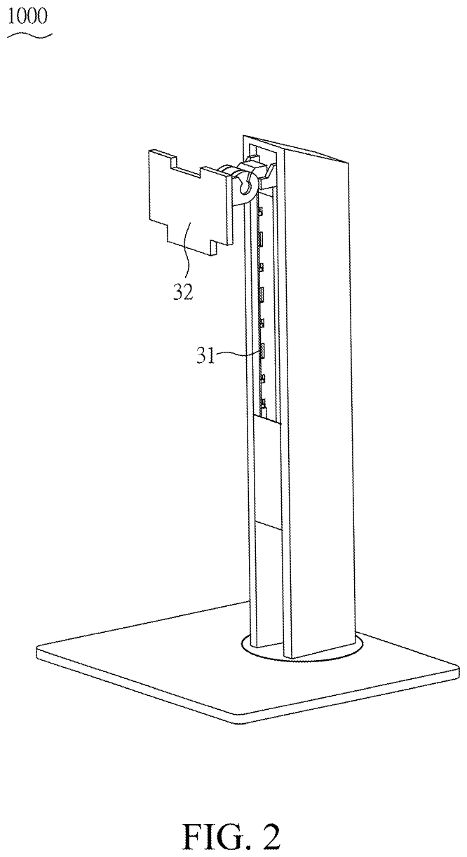

The bearing module 3 is disposed in the accommodating space 24 and fixed to the supporting plate 23 through a plurality of screws, wherein these screws penetrate through the locking holes 231 of the supporting plate 23 and are screwed to the bearing module 3. The bearing module 3 may be any kind of bearing module for carrying a display 4000 in the art, however, in the present embodiment, the bearing module 3 includes a lifting unit, which can moves up and down with respect to the frame 2. Please refer to FIG. 2, the bearing module 3 includes a pair of slide rails 31 (only one is shown due to the view angle) and a slider 32. The slide rails 31 are respectively fixed to different inner surfaces of the frame 2, and the slider 32 is slidably clamped between the slide rails 31. Namely, the slider 32 can move up and down relative to the frame 2.

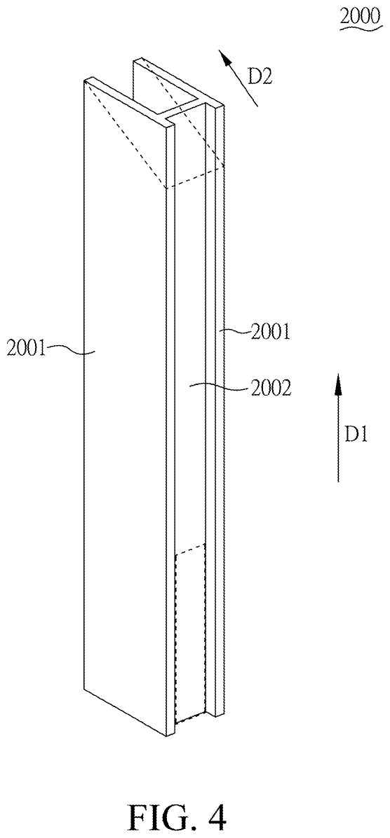

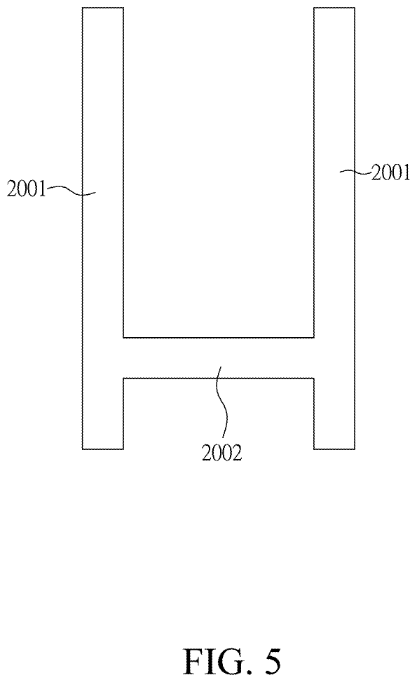

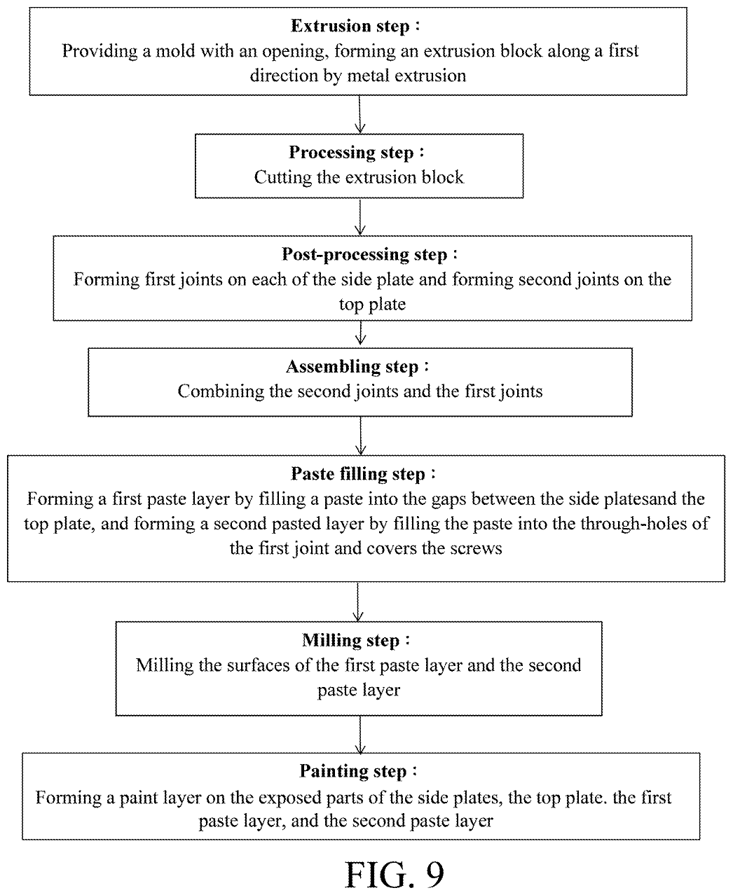

The method of manufacturing the frame 2 will be described as followed. Refer to the preparation flowchart shown in FIG. 9, first, an extrusion step is performed by providing a mold with an opening, forming an extrusion block 2000 along a first direction D1 by metal extrusion. The perspective view of the extrusion block 2000 is shown in FIG. 4, and a cross-sectional view of the extrusion block 2000 vertical to the first direction D1 is shown in FIG. 5. The extrusion block 2000 has an H-shaped cross-section, and the opening of the mold also has the identical H shape as shown in FIG. 5. The extrusion block 2000 includes two side primary boards 2001 extending along the first direction D1 and a middle primary board 2002 connected to the side primary boards 2001. The side primary boards 2001 are parallel to each other while the middle primary board 2002 is sandwiched between and vertical to the side primary board 2001.

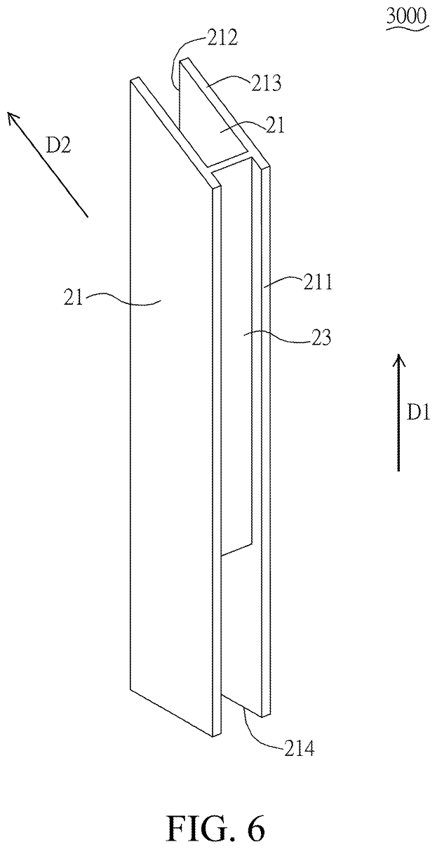

Then, a processing step is performed by cutting the extrusion block 2000 along the dotted line in FIG. 4 for forming an elongated body 3000 shown in FIG. 6. The elongated body 3000 includes two side plates 21 and a supporting plate 23. Each of the side plates 21 has a first edge 211, a second edge 212, a top edge 213, and a bottom edge 214, wherein a length of the first edge 211 is smaller than a length of the second edge 212, and the top edge 213 is angularly connected to the first edge 211 and the second edge 212 and extends along a second direction D2. The first direction D1 and the second direction D2 are non-parallel and include an angle smaller than 90° therebetween. The supporting plate 23 is closed to the first edges 211.

Next, a post-processing step is performed for forming two first joints 216 on each of the side plates 21 and forming four second joints 221 on the top plate 22. In detail, two through-holes 2162 are formed on each of the side plates 21 and two screws 2161 corresponding to the through-holes 2162 are provided, wherein a set of a screw 2161 and a through-hole 2162 is considered as one first joint 216; therefore, the total number of the first joints 216 on two side plates 21 is four. Four blind holes 2211 formed on the top plate 22 correspondingly to the first joints 216 are considered as the second joints 221. Moreover, three blind holes are formed on the bottom edge 214 of each of the side plates 21 as three second engaging structures 215, six stubs are formed on the base 1 as six first engaging structures 11 for engaging the second engaging structures 215.

Besides, the post-processing step further includes the step of forming a plurality of locking holes 231 on the supporting plate 23. The number and the structure of the locking holes 231 are determined according to the structure and the weight of the bearing module 3 and are not particularly limited.

An assembling step is then performed by combining the second joints 221 and the first joints 216. That is, the screws 2161 penetrate into the through-holes 2162 and are screwed in the blind holes 2211 so that the top plate 22 is fixed between the side plates 21 and adjacent to the top edges 213.

Then, a puttying step is performed by forming a first putty layer 25 by filling a putty into the gaps between the side plates 21 and the top plate 22, and forming a second putty layer 26 by filling the puttying into the through-holes 2162 of the first joints 216 and covering the screws 2161. By forming the first putty layer 25 and the second putty layer 26, the outer appearance of the frame 2 becomes relatively smooth and can eliminate the appearance defects caused by assembly between the components. In other embodiments, the second putty layer 26 is not limited to be filled in the through-holes 2162 of the first joints 216 and cover the screws 2161. The second putty layer 26 may be formed according to the structures of the first joints 216 and the second joints 221 as long as the gaps or recesses, which are formed after combining the first joints 216 and the second joints 221, are filled to present a smooth outer appearance.

Then, a milling step is performed by milling the surfaces of the first putty layer 25 and the second putty layer 26 for making them glossy.

At last, a painting step is performed by forming a paint layer 27 on the exposed parts of the side plates 21, the top plate 22, the first putty layer 25 and the second putty layer 26. Accordingly, the outer appearance of the frame 2 is smooth, glossy, and visually integrally-formed.

In other embodiments, a backboard 4 can be disposed to cover the supporting plate 23 from a side adjacent to the first edges 211 of the side plates 21 as shown in FIG. 3.

The above disclosure is related to the detailed technical contents and inventive features thereof. People skilled in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A supporting stand for supporting a display on a working surface, the supporting stand comprising:
a base being placed on the working surface;
a frame being disposed on the base and including two side plates, a top plate, at least one supporting plate, a first putty layer, and an accommodating space surrounded and defined by the side plates, the top plate, and the at least one supporting plate, wherein the top plate is disposed between the side plates and the first putty layer is filled in a gap between the top plate and the side plates; and
a bearing module being disposed in the accommodating space and bearing the display;
wherein the side plates and the at least one supporting plate is an integrally-formed one-piece metal extrusion, each of the side plates includes a first edge, a second edge corresponding to the first edge, a top edge, and a bottom edge, wherein the first edges and the second edges extend along a first direction, the top edges extend along a second direction and are adjacent to the top plate, the at least one supporting plate is adjacent to the first edges, and the frame is connected to the base through the bottom edges of the side plates, wherein a length of the first edges and a length of the second edges are different.

2. The supporting stand as claimed in claim 1, wherein the first direction and the second direction are non-parallel to each other and include an angle smaller than 90° therebetween.

3. The supporting stand as claimed in claim 2, wherein the frame further includes a paint layer covering the exposed areas of the side plates, the top plate, and the first putty layer.

4. The supporting stand as claimed in claim 3, wherein the paint layer is formed as a continuous and smooth surface on the surfaces of the side plates, the top plate, and the first putty layer for making the frame visually integrally-formed.

5. The supporting stand as claimed in claim 4, wherein each of the side plates further includes at least one first joint, and the top plate includes at least one second joint corresponding to and being engaged to the at least one first joint.

6. The supporting stand as claimed in claim 5, wherein the at least one first joint has a through-hole and a screw, the at least one second joint has a blind hole, wherein the screw penetrates into the through-hole and is screwed to the blind hole.

7. The supporting stand as claimed in claim 6, wherein the frame further includes a second putty layer, the second putty layer is filled in the through-hole and covers the screw.

8. The supporting stand as claimed in claim 7, wherein the paint layer further covers the exposed area of the second putty layer.

9. The supporting stand as claimed in claim 7, wherein the first putty layer and the second putty layer include stone powder, synthetic resin, and hardener, wherein the stone powder is calcium silicate, calcium carbonate, or a mixture thereof.

10. The supporting stand as claimed in claim 7, wherein the paint layer includes a primer, a hardener, and a diluent, wherein the primer includes a rosin, a synthetic resin, an organic solvent, and a colorant.

11. The supporting stand as claimed in claim 1, wherein the at least one supporting plate has at least one locking hole, the bearing module is locked to the at least one supporting plate through at least one locking screws.

12. The supporting stand as claimed in claim 1, wherein each of the side plates includes at least one second engaging structure formed on the bottom edge, the base includes at least one first engaging structure corresponding to the at least one second engaging structure, wherein the at least one first engaging structure and the at least one second engaging structure are engaged to each other.

13. The supporting stand as claimed in claim 1, wherein the side plates and the at least one supporting plate are made of aluminum or aluminum alloy.

14. The supporting stand as claimed in claim 1, wherein the bearing module includes at least one slide rail and a slider, the at least one slide rail is fixed to the frame, and the slider is slidably disposed on the at least one slide rail and slides with respect to the frame.

15. The supporting stand as claimed in claim 1, further comprises a backboard covering the at least one supporting plate from a side adjacent to the first edges of the side plates.
